(19) United States
(12) Patent Application Publication
(10) Pub. No.: US 2004/0096615 A1
(43) Pub. Date: May 20, 2004

(54) Hose comprising modified nylon 6,12 material

(75) Inventors: Iani Manas-Zloczower, Orange, OH (US); Roger C. Schley, Parma, OH (US); Craig A. Danko, Lewis Center, OH (US); Roger J. Lewicki, Brecksville, OH (US)

Correspondence Address: Christopher B. Fagan, Esq., Fay, Sharpe, Fagan, Minnich & McKee, LLP, 1100 Superior Avenue, 7th Floor, Cleveland, OH, 44114-2518, US

(73) Assignee: Saint-Gobain Performance plastics Corp.

(21) Appl. No.: 10/298,322

(22) Filed: Nov. 18, 2002

(51) Int. Cl. B32B 1/08

(52) U.S. Cl. 428/36.9; 428/36.91; 264/173.19

(57) ABSTRACT

A copolymer of nylon 6 (caprolactam mer units) and nylon 12 (dodecanolactam mer units) and/or nylon 11 (undecanolactam mer units), which has been modified to provide improved physical properties, such as flex modulus, elastic modulus, and yield strength, serves as a layer of a hose suited to use in airbrake applications. The modified copolymer is resistant to degradation by zinc chloride and moisture and thus may be used as a peripheral layer of the hose in place of a conventional protective layer comprising a pure polyamide, such as nylon 11 or 12. Alternatively, the modified copolymer may be used as a tie layer for rendering a peripheral layer comprising nylon 12 or 11 compatible with a layer of nylon 6, allowing the less expensive nylon 6 material to comprise the bulk of the hose thickness. The layer includes a compatibilizer, such as a maleic anhydride grafted polyethylene, and may also include plasticizers and impact modifiers.

### BACKGROUND OF THE INVENTION

1. Field of the Invention

The invention relates to a modified nylon 6,12 material suited to use in forming hoses for use in air brake systems and other applications where hoses are pressurized with a gas. In particular, it relates to hose in which the modified material acts as a structural layer for the hose, and will be described with particular reference thereto.

2. Discussion of the Art

Air brake systems are widely used in heavy duty vehicles, such as tractor trailers an the like. In such systems, the brake system is connected with a source of compressed air by a flexible tube or hose, which kept pressurized at about 8.4-10.5 kg/cm² (120-150 psi). Tubing formed from a polyamide, such as nylon, is disclosed in Brumbach, U.S. Pat. No. 3,062,241, and is widely used for this purpose. Typically, air brake hoses are formed of a multi-layer construction, with inner and outer layers being formed of a material which resistant to the surrounding environment. In particular, the inner and outer layers are formed from a material which is not sensitive to stress cracking by zinc chloride, such as nylon 11 (polyundecanolactam) or nylon 12 (polydodecanolactam). The inner and outer layers are separated by an intermediate layer of woven or braided material, such as a polyester fiber, which acts as a reinforcement.

Nylon 6 (polycaprolactam) has been considered to be unsuited to use in air brake hoses due to its susceptibility to stress cracking if it comes into contact with zinc chloride. Zinc chloride resistance of hoses is particularly important in areas where road salt is used to melt ice and snow and in marine environments. Hose connectors are frequently zinc plated and, when contacted with sodium chloride from salt spray and the like, form zinc chloride. The zinc chloride attacks nylon 6, causing it to break down. Additionally, nylon 6 tends to become brittle at very low temperatures, typically at about −40° C.

Nylon 11 and nylon 12 are not, however, without some concerns. They are both unsuited to use at temperatures below about −40° C. or at high temperatures, i.e., higher than about 95° C. Additionally, the cost of nylon 11 and nylon 12 is significantly higher than nylon 6 and there are a limited number of suppliers from which these materials can be obtained.

It is considered desirable to form a hose having the zinc chloride resistant properties of nylon 11 or 12 while providing the cost and structural advantages of nylon 6. However, nylon 6 is not compatible with nylon 11 and nylon 12. This means that adjacent layers of nylon 6 and nylon 11 or nylon 12 do not form a cohesive laminate structure when coextruded.

In U.S. Pat. No. 5,076,329 to Brunnhofer, a five-layer fuel line is proposed which is composed of a thick outer layer formed of nylon 11 or nylon 12, a thick intermediate layer of nylon 6, and a thin intermediate bonding layer between and bonded to the intermediate and outer layers formed of a polyethylene or a polypropylene. On the interior of the tube is an inner layer of nylon 6 with a thin intermediate solvent-blocking layer formed of an ethylene-vinyl alcohol copolymer transposed between.

In U.S. Pat. No. 5,038,833 to Brunnhofer, a three-layer fuel line is proposed in which a tube is formed having a co-extruded outer wall of a polyamide, such as nylon 11 or nylon 12, an intermediate alcohol barrier wall formed from an ethylene-vinyl alcohol copolymer, and an inner water-blocking wall formed from nylon 11 or nylon 12. In U.S. Pat. No. 5,219,003 to Kerschbaumer, a fuel line is proposed in which an intermediate solvent barrier layer is formed of unmodified nylon 6,6 (polyhexamethylene adipamide) either separately or in combination with blends of polyamide elastomers. The internal layer is also composed of polyamides; preferably modified or unmodified nylon 6 while the outer layer is composed of either Nylon 6 or nylon 12.

For pressurized gas hoses, such as air brake hoses, the structural and chemical requirements are generally different from those for fluid lines. Hoses with intermediate layers which are not compatible with the adjacent nylon layers or which use an adhesive layer to provide bonding between incompatible layers tend to lack the desired mechanical properties and lamination strength to meet the rigorous standards for air brake hoses.

Nylon 6,12 materials have been formed by copolymerization of nylon 6 and nylon 12 monomer units. However, commercially available nylon 6,12 materials of this type are unsuited to use in air brake hoses due to their high stiffness.

The present invention provides a new and improved airbrake hose material which overcomes the above-referenced problems and others.

### SUMMARY OF THE INVENTION

In accordance with one aspect of the present invention, a hose suitable for use in pressurized fluid systems is provided. The hose includes a first layer which comprises a polyamide which includes mer units of caprolactam and mer units of at least one of undecanolactam and dodecanolactam and a compatibilizer. The compatibilizer is selected from the group consisting of polyolefins modified with an α, β-unsaturated carboxylic acid, polyolefins modified with an alicyclic carboxylic acid, derivatives of polyolefins modified with an α, β-unsaturated carboxylic acid, derivatives of polyolefins modified with an alicyclic carboxylic acid, and combinations thereof.

In accordance with another aspect of the invention, a hose is provided. The hose includes a first layer which includes a copolymer comprising at least one of a nylon 6,12 copolymer and a nylon 6,11 copolymer. The hose further includes at least one of a second layer and a third layer bonded directly to the first layer. The second layer, where present, includes nylon 6. The third layer, where present, includes nylon 12 when the copolymer comprises the nylon 6,12 copolymer, and nylon 11 when the copolymer comprises the nylon 6,11 copolymer.

In accordance with another aspect of the invention, a method of forming a hose is provided. The method includes coextruding a first layer and a second layer, the first layer bonding to the second layer as the layers are coextruded. The first layer includes a copolymer of nylon 6 and either nylon 12 or nylon 11, and a compatibilizer, which renders the first layer compatible with the second layer for coextrusion. The second layer includes nylon 6.

In accordance with another aspect of the present invention, a hose is provided. The hose includes an inner peripheral surface and an outer peripheral surface. The outer peripheral surface is radially outwardly spaced from the inner peripheral surface. A layer defines at least one of the inner and outer peripheral surfaces. The layer comprises at least about 50% by weight of a nylon 6, nylon 12 copolymer and a maleic anhydride modified polymer.

An advantage of at least one embodiment of the present invention is that it enables an air brake material hose to incorporate nylon 6 as an interior layer.

Another advantage of at least one embodiment of the present invention is the provision of an air brake hose with improved mechanical properties and laminate strength.

Another advantage of at least one embodiment of the present invention is that it enables a hose to be formed in which all polyamide layers are replaced with a modified nylon 6,12 material.

Still further advantages of the present invention will be readily apparent to those skilled in the art, upon a reading of the following disclosure and a review of the accompanying drawings.

### BRIEF DESCRIPTION OF THE DRAWINGS

FIG. 1 is a perspective view of an air brake hose in partial section, in accordance with the present invention;

FIG. 2 is a cross sectional view of a second embodiment of a hose, in accordance with the present invention;

FIG. 3 is a cross sectional view of a third embodiment of a hose in accordance with the present invention;

FIG. 4 is a cross sectional view of a fourth embodiment of a hose in accordance with the present invention;

FIG. 5 is a cross sectional view of a fifth embodiment of a hose in accordance with the present invention;

FIG. 6 is a cross sectional view of a sixth embodiment of a hose in accordance with the present invention;

FIG. 7 is a cross sectional view of a seventh embodiment of a hose in accordance with the present invention; and

FIG. 8 is a multilayer film according to the present invention.

### DETAILED DESCRIPTION OF THE PREFERRED EMBODIMENT

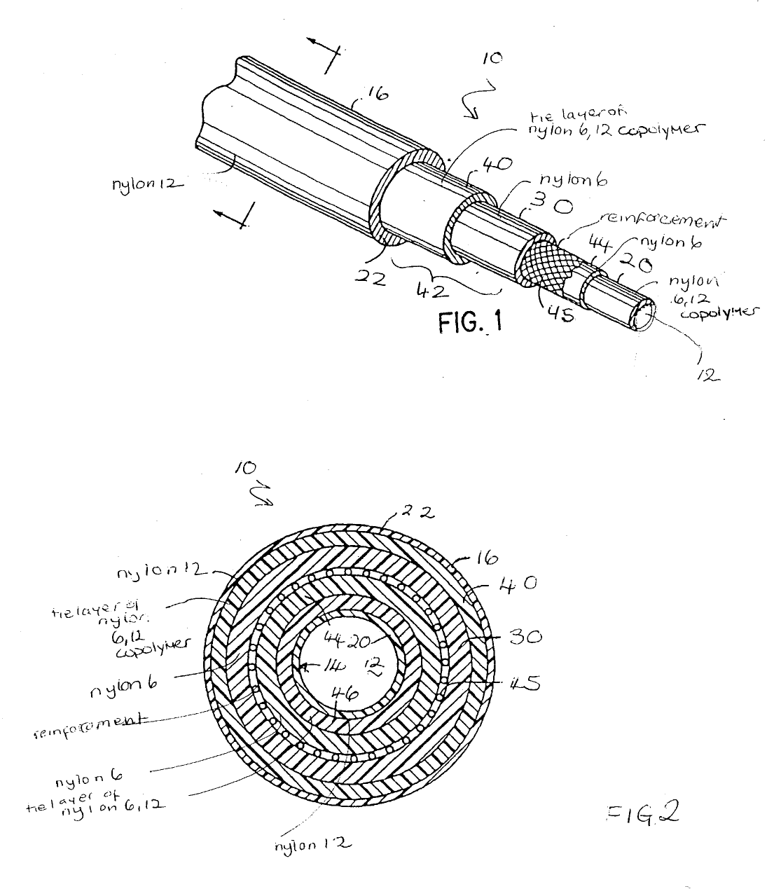

FIG. 1 illustrates a hose or tube 10 which is suited to use in systems where the hose is pressurized with air, such as an air brake system for a vehicle, or in a tool which is operated by pressurized air. While particular reference is made to pneumatic systems employing pressurized gases, such as air, as the hose pressurizing medium, it is also contemplated that the hose be used with hydraulic pressurization (e.g., water or oil) or other liquid pressurizing media. The hose may also be used in systems where the fluid to be transferred is at or close to atmospheric pressure.

When used in an air brake system, the hose 10 is used or connecting a source of applied pressure, such as a compressor (not shown), with a braking system for the vehicle (not shown), and optionally with a reservoir for pressurized gas intermediate the compressor and brake system. The hose is maintained under a positive pressure of about 8-12 kg/cm² for extended periods.

The hose 10 is preferably of a laminate construction, one or more layers of the hose being formed of a modified nylon 6,12 copolymer, or similar copolymer, which is described in further detail below. The nylon 6,12 copolymer has good zinc chloride and moisture resistance properties and flexibility and yet is compatible with nylon 6. As a result, layers of nylon 6 and the nylon 6,12 copolymer can be coextruded as directly adjacent layers, having laminate strength, without the need for any adhesive between the two layers or other bonding medium.

The copolymer includes residues (which are referred to generally as mer units) of a first monomer and a second monomer. The first monomer provides the copolymer with zinc chloride resistance. The second monomer may have substantially less zinc chloride resistance, when polymerized, than the first monomer, but when combined with residues of the first monomer, yields a copolymer having sufficient zinc chloride resistance to render the copolymer suitable use in zinc chloride environments. Suitable first monomers include undecanolactam, which will be referred to herein as nylon 11, and dodecanolactam, which will be referred to as nylon 12. Suitable second monomers include caprolactam, alone, or combined with adipic acid residues. Thus, while the hose material is described with particular reference to a nylon 6,12 copolymer (i.e., a copolymer derived from the copolymerization of caprolactam and dodecanolactam, it is to be appreciated that the nylon 6 monomer units in the copolymer may be replaced, in whole or in part, by mer units of another polyamide derived from caprolactam, such as nylon 6,6 (a polymer of caprolactam and adipic acid), nylon 4, 6 (a polymer of tetramethylenediamine-co-adipic acid and caprolactam), and the like. The nylon 12 in the copolymer may be replaced, in whole or in part, with mer units which have similar zinc chloride resistance to nylon 12, such as nylon 11.

For air brake applications, it is preferred that nylon 6 is not directly exposed to the environment to avoid zinc chloride degradation. It is therefore desirable to have an outer layer formed from a zinc chloride resistant material, such as the nylon 6,12 copolymer, to space the nylon 6 from the surrounding environment. Or, the nylon 6,12 copolymer may be used on its own, without any other polyamide layers. In yet another embodiment, the nylon 6,12 copolymer may be used as a tie layer, i.e., as a thin layer, which is compatible with two adjacent layers, such as both a nylon 6 layer and a zinc chloride resistant layer, such as a layer of nylon 12.

While for convenience, layers of the hose 10 are described in general terms as “nylon 6,12 copolymer,” “nylon 6,” “nylon 12,” or the like, it is to be appreciated that the layers frequently also contain a variety of other ingredients, such as plasticizers, impact modifiers, flexibilizers, and the like, as will be described in greater detail below. It is also contemplated that other polyamides be incorporated into the layers, provided these do not have a significant deleterious impact on the properties of the material or the compatibility of the material with the adjacent layer(s).

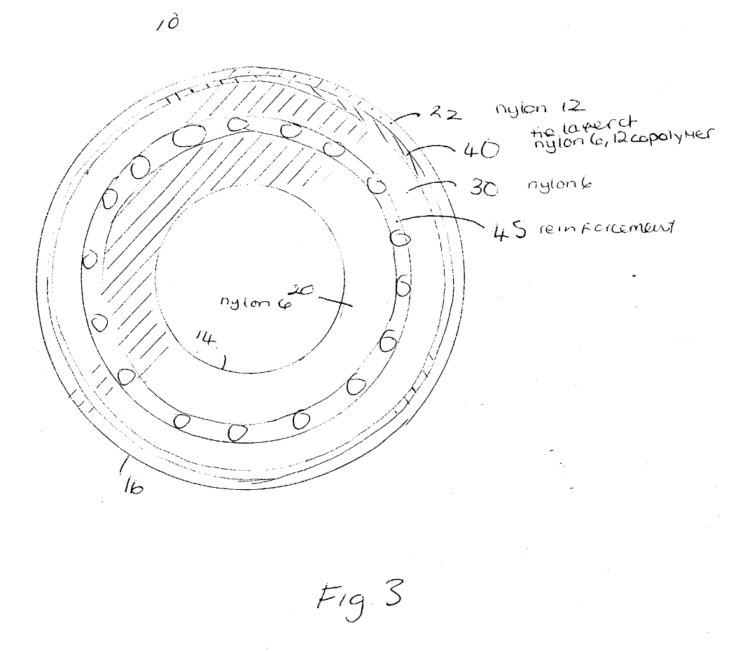

The hose 10 defines a hollow interior 12, which receives the pressurized air or other pressurized medium therein. As shown in FIG. 2, which shows a slightly modified hose 10, an inner peripheral surface 14 of the hose is in contact with the air. An outer peripheral surface 16 of the hose is in contact with the exterior environment, and is thus subject to being contacted by moisture and air and waterborne contaminants, such as zinc chloride. The hose 10 includes an inner peripheral layer 20, which defines the inner peripheral surface 14, and an outer peripheral layer 22, spaced radially outward of the inner layer 20, which defines the outer surface 16. Although layers 16 and 20 are intended to be used as peripheral (i.e., outermost and innermost) layers, it is to be appreciated that additional layers of material (not shown) optionally space the outer surface 16 from the environment or the inner surface 14 from the pressurized medium.

The outer peripheral layer 22 of FIGS. 1 and 2 is formed from a material which is resistant to zinc-chloride degradation, such as nylon 12. The layer 22 is of sufficient thickness to provide isolation of radially inward layers of the hose from the automotive environment, such as moisture and zinc chloride. Where zinc chloride degradation is of particular concern, or where automotive specifications require use of nylon 12 or other single polyamide, nylon 12 is preferred as the outer layer 22. It is desirable, due to the cost of nylon 12 (and, to a lesser extent, the nylon 6,12 copolymer) relative to other polyamides, such as nylon 6, to have the outer layer 22 as thin as possible, while ensuring zinc chloride protection for the useful lifetime of the hose 10. Accordingly, layer 22 is preferably about 0.1-0.46 mm, more preferably, about 0.25-0.5 mm in thickness.

In the embodiments of FIGS. 1 and 2, an interior layer 30 of a polyamide, which need not possess zinc chloride and moisture resistance, such as nylon 6, is spaced radially inward of the outer layer 22. Where the outer layer is formed from nylon 12, a tie layer 40 of the nylon 6,12 copolymer is interposed between the nylon 6 and nylon 12 layers 30, 22 to render them compatible for coextrusion. The tie layer 40 is generally thinner than either of the two adjacent layers, for example 0.0025-0.005 mm in thickness, although greater or lesser thicknesses are also contemplated. The layers 22, 30 and 40 (where present) form a jacket 42 of the hose 10. The total thickness of the jacket is preferably about 0.8-1.2 mm.

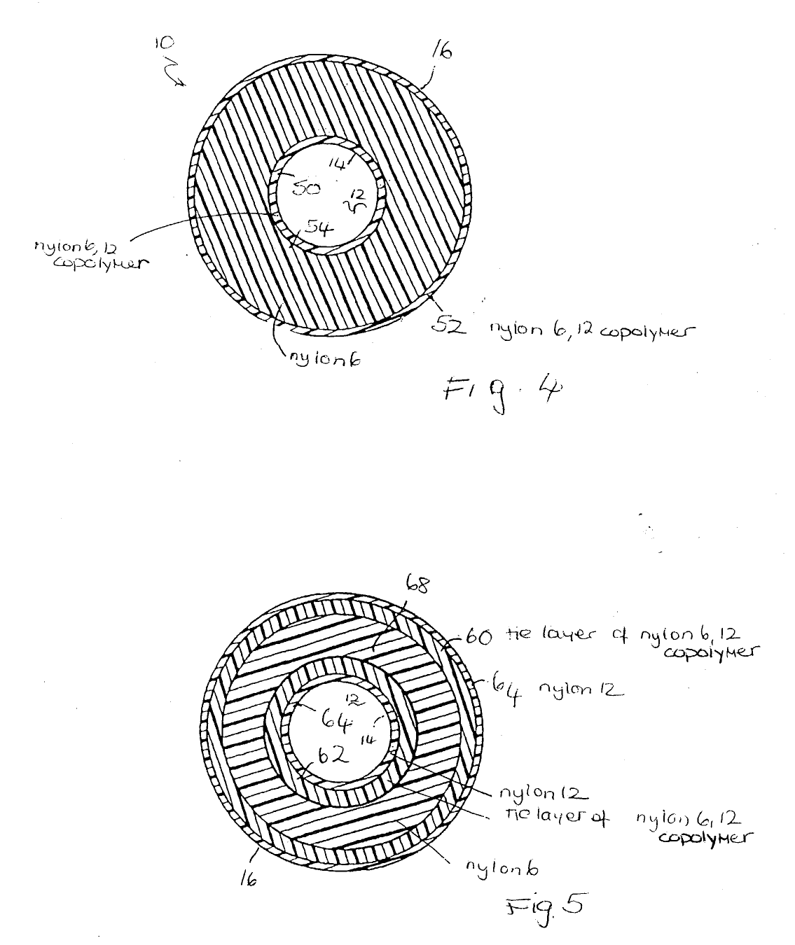

If the outer layer 22 is formed from the nylon 6,12 copolymer, as is the case in the embodiment of FIG. 4, the two layers 22, 30, may be adjacent (i.e., without intermediate layers between them), since the nylon 6,12 copolymer is compatible with nylon 6 and may be coextruded therewith. No other intermediate layer, such as an adhesive layer, is necessary.

The inner layer 20 is shown in FIG. 1 as comprising a layer of the nylon 6,12 copolymer. Layer 20, in this embodiment, is preferably about 0.1-0.5 mm, more preferably, about 0.25 mm in thickness. An interior layer 44 of a material compatible for coextrusion with the nylon 6,12 copolymer layer is spaced radially outward of the inner layer 20. For example, layer 44 may be a similar nylon 6 material to that employed for layer 30. Layer 44 is preferably compatible with the innermost layer 30 of the jacket so that the two layers 44, 30 are compatible for coextrusion. In the preferred embodiment, layers 44 and 30 are preferably nylon 6. A layer 45 of a reinforcing material, such as polyester fiber, is embedded at the interface of the adjoining layers 44, 30.

Layer 44 is preferably about 0.5 to 0.9 mm in thickness, more preferably, about 0.6 mm in thickness. The layer 30 is preferably about 0.7 to 1.1 mm in thickness, more preferably, about 0.9 mm. Layers 30 and 44 provide the primary structural support for the tubing. Therefore, their thickness is determined by application requirements. In total, the polyamide layers 22, 40, 30, 44, 20 of the hose are preferably about 1.0-2.5 mm.

Alternatively, as shown in FIG. 2, the inner peripheral layer 20 is formed from nylon 12, with a tie layer 46 of the nylon 6,12 copolymer interposed between the nylon 12 and nylon 6 layers 20, 44 and entirely or substantially coextensive therewith to permit coextrusion of the otherwise incompatible nylon 6 and nylon 12 layers. Layer 46, in this embodiment, is preferably of similar thickness to tie layer 40 of FIGS. 1 and 2, e.g., about 0.0025-0.005 mm in thickness. In this embodiment, layer 20 is preferably as thin as possible to allow cost savings while maintaining the desired zinc chloride and/or moisture protection. For example, layer 20, in this embodiment, is preferably about 0.25 mm in thickness.

The nylon 6,12 copolymer layers are formed from a nylon 6,12 copolymer which is intimately mixed with one or more of a compatibilizer, a plasticizer, an impact modifier, and heat and light stabilizers at a suitable temperature to form a mixture which is then extruded in the form of a layer of the hose.

The nylon 6,12 copolymer is formed by copolymerizing monomers of nylon 6 (caprolactam) and nylon 12 (dodecanolactam), either randomly, or by block copolymerization, to form a copolymer having both nylon 6 and nylon 12 mer units in the molecule.

The number average molecular weight of the copolymer is preferably at least about 5.000, more preferably, at least 10,000, and most preferably, in the range of about 10,000 to about 100,000. While it is anticipated for convenience that the polyamides used in the formulation is 100% of the nylon 6,12 copolymer, it is to be appreciated that all or a portion of the nylon 6,12 copolymer may be replaced with a compatible polyamide. For example, an amount of a nylon 6 polymer resin or nylon 12 polymer resin may be added to the formulation, for example, to modify the relative proportions of nylon 6 and nylon 12 in the formulation.

It will be readily appreciated that commercially available nylon 6,12 copolymers, nylon 6 polymer, and nylon 12 polymer may contain an amount of the residual monomer (caprolactam or dodecanolactam), which is not deleterious.

The nylon 6,12 copolymer used for layers 20, 40, and 46 preferably has the following characteristics:

Ambient flex modulus: 2800-7000 kg/cm² (40,000-100,000 psi), preferably about 3500 kg/cm² (50,000 psi) (as measured by ASTM Standard ASTM D-790).

Elastic modulus @ 110° C. (230° F.): 700-1750 kg/cm² (10,000-25,000 psi), preferably about 1400 kg/cm² (20,000 psi) (as measured by ASTM Standard ASTM D-638).

Yield Strength @ 110° C. (230° F.): 70-140 kg/cm² (1000-2000 psi), preferably about 105 kg/cm² (1500 psi) (as measured by ASTM Standard ASTM D-638).

Notched Izod Impact Strength @ −40° C.: about 0.7 ft-lbs/in, or greater, preferably, about 1.6 ft-lbs/in) (as measured by ASTM Standard ASTM D-256).

The nylon 6,12 copolymer layers 20, 40, and 46 preferably comprise about 50-90%, more preferably, about 50-85%, and most preferably, about 65-85% polyamide, either as 100% nylon 6,12 copolymer or a mixture of the nylon 6,12 copolymer with nylon 6 and/or nylon 12 polymers. The ratio of nylon 6 mer units to nylon 12 mer units in the copolymer is preferably in the ratio of from about 3:1 nylon 6 mer units: nylon 12 mer units to about 1:3 nylon 6 mer units: nylon 12 mer units, more preferably from about 2:1 to 1:2 nylon 6: nylon 12, and most preferably, about 1.2:1 nylon 6: nylon 12. If the ratio of nylon 6: nylon 12 is significantly lower than 1:3 or higher than 3:1, the layer may not be sufficiently compatible with adjacent nylon 6 or nylon 12 layers to coextrude the layers to form a hose having the desired laminar strength for use with air brakes. When used as a structural layer rather than simply as a tie layer, the nylon 6 content is preferably below about 40% as otherwise, the stiffness of the resulting hose may be too high for air brake applications.

Suitable nylon 6,12 copolymers are those which are commercially available from DuPont and Huls. Nylon 6 resin suited to the present process is commercially available from BASF AG, Geismar, Louisiana, USA under the tradename Ultramid™ B35. Nylon 12 resin is obtainable from ATOFINA, USA, as Rislan™ AESNO P40 or AESNO P401TL. The polyamide resins are preferably in the form of pellets, although other comminuted particles are also contemplated.

The compatibilizer in the nylon 6,12 copolymer formulation serves to improve the bonding between the nylon 6 and nylon 12 polymers in adjacent layers during the extrusion process (or in the layer itself, where present in the formulation). Preferably, the compatibilizer chemically bonds to the nylon 6,12 copolymer and to nylon 6 and nylon 12 polymers. This provides a material with the chemical, strength, and flexural properties to make it suitable for use as a tie layer 40, 46 or a zinc chloride resistant outer layer 16, 20 of the hose 10. The compatibilizer preferably also improves flexibility.

Suitable compatibilizers are polyolefins modified with an α, β-unsaturated carboxylic acid, an alicyclic carboxylic acid, or derivatives thereof, such as acrylic acid, methacrylic acid, maleic acid, fumaric acid, itaconic acid, endocyclo(2,2,1)-5-heptene-2,3-carboxylic acid, and cis-4cyclohexene-1,2-carboxylic acid and anhydrides, esters, amides, and imides thereof.

Preferred compatibilizers are maleic anhydride modified polymers, such as maleic anhydride grafted polyolefins. Preferred olefins are ethylene and propylene, or combinations thereof, ethylene being particularly preferred. These polymers have a polyolefin backbone to which maleic anhydride residues are attached in a random fashion. The modified polypropylenes generally contain about 0.5% to about 10% of maleic acid or maleic anhydride, based on the total weight of the modified polymer. Preferably, the modified polymer is about 1% weight percent maleic anhydride, or less, i.e., only a small percentage of the olefin mer units are modified with the maleic anhydride in this way. A particularly preferred compatibilizer is maleic anhydride grafted polyethylene (MAGPE), which can be obtained from E. I. DuPont under the tradename Fusabond™ MN-493D. Other suitable compatibilizers include acrylic acid modified polymers, such as acrylic acid modified polyolefins. The compatibilizer is preferably present at about 5-30% by weight of the formulation, more preferably, from about 10-20%, and most preferably, about 13% by weight of the formulation. The MAGPE also improves flexibility.

The maleic anhydride modified polymer or other suitable compatibilizer should be in the molten state to initiate the covalent bonds necessary for strong adhesion between the polyamides. Adhering to cold substrates using this so-called adhesive thermoplastic elastomer is generally unsuccessful. Little or no covalent bonds will form at the interface and the adhesion is therefore generally inadequate.

The formulation also preferably includes one or more of plasticizers and impact modifiers. The plasticizer serves to render the layer more flexible and so that it retains its flexibility under use conditions particularly when subject to low temperatures. The plasticizer is generally a liquid at room temperature. Suitable plasticizers are those which are stable at the processing temperatures of the formulation (typically at about 220° C.) and include alkyl aryl sulfonamides, such as butyl benzene sulfonamide. This plasticizer is available from Unitex under the tradename Uniplex™ 214. Another plasticizer is residual nylon 6 monomer (caprolactam). This material is naturally present in certain grades of nylon 6 at a level of about 2%, or less. The plasticizer is preferably present in the formulation at about 0-20%, more preferably, at about 10% or less by weight of the formulation. Certain commercially available nylon, 6,12 resins may already incorporate a plasticizer, rendering an additional plasticizer unnecessary.

Suitable impact modifiers include maleic anhydride-grafted polyolefin rubbers comprising an ethylene/propylene or ethylene/butene copolymer rubber and about 0.5% to about 10% of a diene, preferably about 2% to about 6%, such as maleic anhydride grafted ethylene/propylene/diene elastomers (MAGEPDM). The elastomer is preferably about 30% to about 70%, preferably about 40% to about 60%, ethylene, and about 0.4-2% grafted maleic anhydride. The ratio of ethylene/propylene is preferably about 75/25. The diene may be butadiene; 1,4-hexadiene; 1,5-hexadiene, ethylidenenorbornene, or the like. Suitable maleic anhydride grafted ethylene/propylene/non-conjugated diene elastomers are commercially available from Crompton Corp. under the tradename Royaltuf™ 498. The impact modifier is preferably present at a concentration of 0-30%, more preferably, 5-25%, and most preferably, about 10-15%.

Such maleic anhydride grafted ethylene/propylene/non-conjugated diene elastomers are colored and render the hose opaque. Where a translucent material is desired, the impact modifier is optionally eliminated. In such cases, the concentration of compatibilizer, plasticizer, and/or resin in the formulation is preferably increased slightly to make up for the weight of impact modifier. It should be noted that the MAGPE in the formulation serves a dual role in that it also serves as an impact modifier as well as a compatibilizer. Thus, where MAGPE is used as a compatibilizer, the presence of an additional impact modifier, such as MAGEPDM, is not essential.

The formulation may also contain suitable heat and light stabilizers, such as hindered amine light stabilizers, at from about 0.5 to 1.0 weight %. The nylon 12 base resin, Rislan™ AESNO P401 TL already contains heat and light stabilizers and if this material is employed in the formulation, additional heat and light stabilizers need not be added.

A preferred Nylon 6,12 copolymer formulation includes:

Nylon 6,12 copolymer: 70-90% by weight; Maleic anhydride grafted polyethylene (MAGPE): 5-30% by weight, more preferably, 5-30% by weight, most preferably, about 10-15%; Plasticizer (butyl benzene sulfonamide): 0-20% by weight;

Maleic anhydride grafted ethylene/propylene/non-conjugated diene elastomer (MAGEPDM): 0-30%, by weight more preferably, 5-25%, and most preferably, about 10-15%;

Heat and light stabilizers: about 1%

Heat is applied to the mixture of polyamide(s) (solid at ambient temperatures), compatibilizer (solid), impact modifier (solid), and plasticizer (liquid) to melt the solid components and for coupling the polyamides with the compatibilizer. Preferably, the temperature is raised above the melting point of the resin, e.g., to about 220° C., or above, such that all or substantially all the polyamide is melted.

For example, the ingredients for the nylon 6,12 copolymer formulation are fed into a twin screw extruder or similar high shear mixing device. The extruder heats the materials to a temperature of about 230-280° C. and mixes the materials. A batch process or continuous feed process may be used. The residence time has some influence on the properties of the material and can be adjusted to optimize the properties desired. The nylon 6,12 copolymer formulation is ejected as a mixture, which is pelletized and stored until needed for forming a layer of the hose. Alternatively, the molten formulation can be fed directly to an extruder for forming the hose.

The nylon 12 layers 16, 20 and nylon 6 layers 30, 44 (where present) may be either modified or unmodified. If modified, it is anticipated that the material will contain various plasticizers as are readily known in the art. Preferably, the polyamide contains up to 17% by composition weight plasticizer; with amounts between about 1% and about 13% being preferred. Suitable plasticizers include butyl benzene sulfonamide or similar plasticizers, as discussed above. The nylon 12 layers 16, 20 (where present) are preferably formed from a plasticized polyamide, such as those which are commercially available from Huls under the tradename X7293 or Atofina's Rislan AESNO P40 or P401 TL. Alloys of nylon 12 may also be employed. Suitable alloys include nylon 12, which is blended with less than 50% by weight of a compatible polymer, such as a maleic anhydride modified high density polyethylene. As discussed above, the term “nylon 12 layer” is intended to include both 100% nylon 12 as well as comparably performing nylon 12 blends.

The nylon 6 used for layers 30 and 44 preferably has the following characteristics:

Ambient flex modulus: 2800-7000 kg/cm² (40,000-100,000 psi), preferably about 5950 kg/cm² (85,000 psi) (as measured by ASTM Standard D-790).

Elastic modulus @ 110° C. (230° F.): 700-2800 kg/cm² (10,000-40,000 psi), preferably about 1400 kg/cm² (20,000 psi) (as measured by ASTM Standard D-638).

Yield Strength @ 110° C. (230° F.): 70-140 kg/cm² (1000-2000 psi), preferably about 105 kg/cm² (1500 psi) (as measured by ASTM Standard D-638).

Izod Impact Strength (notched) @ −40° C.: about 38 joules/meter (about 0.7-2.0 ft-lbs/in), or greater, preferably, about 86 joules/meter (about 1.6 ft-lbs/in) (as measured by ASTM Standard D-256.

The nylon 6 layer 30, 44 preferably includes a plasticized nylon 6 polyamide, and may optionally also include an impact modifier, such as a maleic anhydride modified ethylene/propylene non-conjugated diene elastomer or other impact modifiers or combinations thereof as discussed above. A compatibilizer, such as maleic anhydride modified polyethylene or other compatibilizers or combinations thereof as discussed above, is preferably also present. Since the nylon 6 base resin used may contain a proportion of residual nylon monomer (caprolactam) this may also be present and serve an additional plasticizing function. A preferred nylon 6 formula includes:

Nylon 6 base resin: 50-75%, preferably, about 63%;

Plasticizer: Butyl benzene sulfonamide: 10-16% by weight, preferably, about 14% (e.g., Unitex Uniplex™ 214);

Residual nylon monomer-caprolactam: 5-10% by weight, generally, about 7%;

Maleic anhydride modified ethylene/propylene non-conjugated diene elastomer: 5-15% by weight, preferably, about 10% (e.g., Crompton Royaltuf 498);

Maleic anhydride modified polyethylene: 5-25% by weight, preferably, about 20% (e.g., DuPont Fusabond MN-493D); and

Suitable heat and light stabilizers (about 1%).

To form the tubing 10, the innermost layers 20, 46 (where present) and 44 of nylon 12 (where present), nylon 6,12 copolymer, and nylon 6 are coextruded first. The melt temperature of the nylon extruder is preferably about 235° C. to about 245° C., more preferably, about 238° C.

The reinforcing layer 45 is then added. To form the reinforcing layer 45, the extruded layers 20, 44 (and optionally 46, where present) are passed through a braider or fiber reinforcing apparatus. The reinforcing material may be braided, knitted, or spirally wrapped wherein one strand of the material is applied with a pitch in one direction and another strand is applied over the first with a pitch in the opposite direction. The braider is preferably a counter rotating fiber reinforcing device. Preferably, the braided layer 45 is applied with six bobbins of fiber applied at from two to five picks per inch, more preferably, three picks per inch.

Once the reinforcement is applied, the outer layers 22, 40, 30 forming the jacket 42 are co-extruded over the inner tubing in the same manner as the first two or three layers 20, 46, 44, at the same temperatures. The formed tubing is then passed through a cooling bath. The resulting extruded product 10 has an outer diameter of about 9.0 to about 20 mm and is ready for use.

Since the inner layer 20, is generally not exposed to the effects of zinc chloride degradation, or is much less likely to suffer zinc chloride degradation than the outer layer 22, it is contemplated that the inner peripheral layer 20 may alternatively be formed from a less expensive polyamide, such as nylon 6, nylon 6-6, or other suitable material, as shown in FIG. 3. In this embodiment, the layer 44 is omitted. The hose of FIG. 3 is otherwise similar to that of FIGS. 1 and 2, although it is also contemplated that an outer layer 22 of the nylon 6,12 copolymer may replace the combination of an outer nylon 12 layer 22 and a tie layer 40 of nylon 6,12 copolymer shown.

It is also contemplated that the reinforcing layer 45 may be eliminated as shown in FIGS. 4 and 5. FIG. 4, for example, shows a hose 10 in which inner and outer peripheral layers 50, 52, comprising the nylon 6,12 copolymer formulation of the present invention, are spaced by an interior layer 54 of a compatible material, such as nylon 6. The layers 50, 52 may be of similar thickness to layers 20 and 22 of FIG. 2 (i.e., from about 0.12-0.36 mm in thickness). Layer 54 may be equivalent in thickness to the combined thicknesses of layers 30 and 44 of FIGS. 1 and 2. (i.e., from about 1.0-1.6 mm in thickness). In an alternative embodiment, layers 50 and 52 may be formed from nylon 12 and intermediate layer 54 may be the nylon 6,12 copolymer formulation. In yet another embodiment, layer 50 is eliminated, for example, where zinc chloride resistance of the inner peripheral layer is not of concern. In this latter embodiment, an outer peripheral layer 52 of the nylon 6,12 copolymer formulation and an inner peripheral layer 54 of nylon 6 make up the hose.

In FIG. 5, tie layers 60, 62 of the nylon 6,12 copolymer formulation, which are analogous to layers 40 and 46 of FIG. 2, space outer and inner peripheral layers 64, 66, respectively, from an interior layer 68. Layers 64,66 are formed from nylon 12 and are analogous to layers 22 and 22 of FIG. 2, while layer 68 is formed from nylon 6, analogous to layer 54 of FIG. 4.

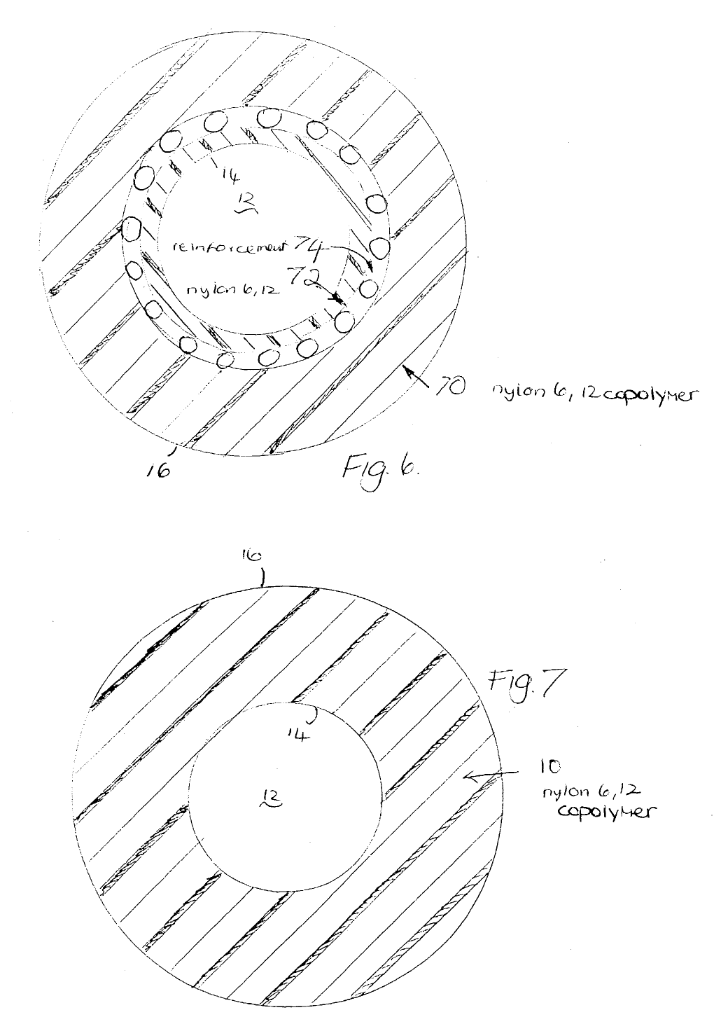

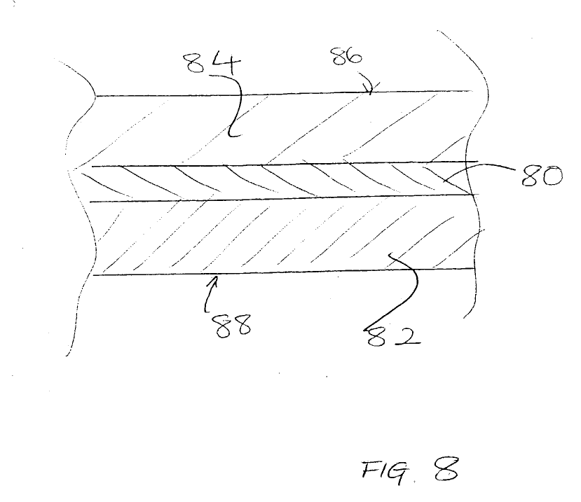

In yet further embodiments, shown in FIG. 6 and 7 the nylon 6,12 copolymer formulation provides all of the polyamide layer(s) in the hose 10. In FIG. 6, an outer peripheral layer 70 of the nylon 6,12 copolymer formulation is coextruded with an inner peripheral layer 72 of nylon 6,12 copolymer formulation and an intermediate reinforcing layer 74. Inner and outer layers 70, 72 may be of the same thickness, or as shown in FIG. 6, one of the layers may be of greater thickness than the other. It is contemplated that the formulation of the nylon 6,12 copolymer formulation for the layers 70, 72 (and in other cases were the copolymer formulation serves are peripheral layers) may be the same or different. For example, the outer peripheral layer 70 may have a higher proportion of nylon 12 than the inner peripheral layer 72, to provide enhanced zinc chloride resistance.

As will also be appreciated from the foregoing, in an alternative embodiment, one or other of layers 70 and 72 of FIG. 6 may be replaced with a layer of a compatible material, such as nylon 12 or nylon 6.

FIG. 7 is analogous to FIG. 6, but without the reinforcing layer. The hose 10 is formed entirely from the nylon 6,12 copolymer formulation.

In an alternate embodiment, some or all of the layers in which the nylon 6,12 copolymer is present are replaced with a layer formed from an alloy of a first polyamide, such as nylon 6, or other polyamide derived from caprolactam, and a second, zinc chloride resistant polyamide, such as nylon 12 or nylon 11. The alloy is formed in a similar manner to the copolymer formulation describe above but uses, for example, nylon 6 and nylon 12 polymer resins in place of the nylon 6,12 resin. The two resins are rendered compatible by a compatibilizer, such as one or more of the compatibilizers described above. The nylon 6 and nylon 12 polymers used for forming the alloy preferably have a number average molecular weight of at least 5000, more preferably, at least about 10,000, and most preferably, from about 10,000-100,000. The proportions of nylon 6 and nylon 12 polymers are preferably in the range of 1:3 to 3:1 nylon 6:nylon 12, more preferably about 2:1 to 1:2 nylon 6: nylon 12, and most preferably, about 1.2:1 nylon 6: nylon 12. If the ratio of nylon 6: nylon 12 is significantly lower than 1:3 or higher than 3:1, the layer may not be sufficiently compatible with adjacent nylon 6 or nylon 12 layers to coextrude the layers to form a hose having the desired laminar strength for use with air brakes.

The nylon 6, nylon 12 alloy formulation thus described may also include one or more of an impact modifier and a plasticizer, analogous to those discussed for the nylon 6,12 copolymer layer formulation. For example, a suitable formulation for forming a nylon 6, nylon 12 alloy layer includes:

Nylon 6 base resin: 30-40% by weight for an opaque formulation, 35-45% for a translucent formulation;

Nylon 12 base resin: 20-35% by weight for an opaque formulation, 25-40% for a translucent formulation;

Maleic anhydride grafted polyethylene (MAGPE): 05-20% by weight, preferably, about 13% for an opaque formulation, about 17% for a translucent formulation;

Plasticizer (butyl benzene sulfonamide): 0-20% by weight, preferably, about 8% for an opaque formulation, about 10% for a translucent formulation;

Residual nylon monomer: 0-10% by weight;

Maleic anhydride grafted ethylene/propylene/non-conjugated diene elastomer (MAGEPDM) 0-20% by weight, preferably about 13% for an opaque formulation, about 0% for a translucent formulation;

Heat and light stabilizers: about 1%

It is also contemplated that a layer of the nylon 6,12 copolymer material may be coextruded with a layer of the nylon 6, nylon 12 alloy. The two materials are compatible with one another and are capable of bonding to one another during coextrusion to form a hose which has a high laminar strength. Thus, for example, layer 40 or 20 of FIG. 1 could be replaced by two (or more) layers, one of the layers being formed from the alloy and the other from the copolymer.

It will be appreciated that other combinations of layers may also make up the hose, taking the following into consideration:

The outer surface 16 of the hose is preferably defined by a zinc chloride resistant layer, which includes one or more zinc-chloride resistant polyamides, such as nylon 11 or nylon 12, either alone or as a copolymer or alloy formulation with a second polyamide, such as the nylon 6,12 copolymer formulation, a compounded nylon 6, nylon 12 alloy, or pure nylon 12;

The inner surface 14 of the hose is preferably defined by a zinc chloride resistant layer, such as the nylon 6,12 copolymer formulation, a compounded nylon 6, nylon 12 alloy, or nylon 12, although this is generally less important than for outer surface 16; and

A tie layer, where used, preferably comprises polyamides which are present in the two adjacent layers. For example, where a nylon 12 layer is employed, it is spaced from any layer(s) of nylon 6 present by a tie layer which is compatible with both layers, such as a layer of the nylon 6,12 copolymer formulation, or the compounded nylon 6, nylon 12 alloy, in the case of a nylon 12 layer.

While the invention has been described with particular references to hoses, it will be appreciated that other multi-layer structures may also be formed with a layer of the copolymer of the present invention, such as a nylon 6, 12 copolymer. For example, as shown in FIG. 8, a multi-layer film is shown. The film includes a first layer 80 of the nylon 6, 12 copolymer, formulated as described above. A second layer 82 of nylon 6 (or similar caprolactam-based polyamide present in the copolymer) and/or a third layer 84 of nylon 12 (or other polyamide present in the copolymer), are optionally coextensive with the first layer, and may be formed by a lamination process similar to the coextrusion process described above. While the film is shown as having opposed upper and lower exterior surfaces 86, 88, defined by layers 84 and 82, respectively, it will be appreciated that additional layers may also be present in the structure to suit particular applications. As discussed for the hose, the copolymer formulation may also provide one or other of the outer layers of a film.

Without intending to limit the scope of the invention, the following Example describes methods of preparation of various nylon 6,12 copolymer formulations and compares the formulations with other polyamide formulations.

### EXAMPLE

Comparison of the Performance of Nylon 6,12 Copolymer Formulations with other Polyamide Formulations

Various polyamide formulations were prepared using the following polyamides: a nylon 6,12 copolymer (Formulations 1 and 3), a nylon 6,12 copolymer modified with a compatibilizer (Formulation 4), and a nylon 6,12 copolymer modified with an impact modifier and compatibilizer (Formulations 7 and 8) a nylon 6, nylon 12 alloy (Formulations 5, 6, and 9), and a nylon 6 polymer (Formulation 2). The mixtures were heated to a sufficient temperature to melt the polyamides using a twin screw mixer with a Maddox® screw and pelletized. Samples of the formulations were heated in a Brabender mixer and extruded through a 1″ die to form ribbons for analysis. The screw was rotated at 60 RPM. The ribbons were cooled and tested to determine their suitability as a tie layer.

Testing Procedures were used as follows:

Izod Impact Strength (notched) @ −40° C.: ASTM D-256

Elastic modulus @ 110° C. ASTM D-638

Yield Strength @ 110° C. ASTM D-638

Ambient flex modulus: ASTM D-790

Specific Gravity: ASTM D-792

Table 1 details the results obtained. As can be seen from Table 1, the modified nylon 6,12 copolymer (Formulations 7 and 8) exhibited superior performance characteristics (e.g., lower flex modulus) as a hose layer to the unmodified nylon 6,12 copolymer formulation (Formulations 1 and 3). The nylon 6, nylon 12 alloy (Formulations 5-9), particularly when combined with an impact modifier, plasticizer, and compatibilizer (Formulation 9) also exhibited excellent characteristics as a hose material.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

TABLE 1

| Primary | Trade- | Density | Formulation | | | | | | | | |
|---|---|---|---|---|---|---|---|---|---|---|---|
| Material | name | (g/cc) | 1 | 2 | 3 | 4 | 5 | 6 | 7 | 8 | 9 |
| Nylon 6 alloy | XP-727- | 1.454 | | 100% | | | | | | | |
| | 45 | | | | | | | | | | |
| Nylon 6 | Ultramid | 1.120 | | | | | 30.0% | 37.5% | | | 37.5% |
| | B35 | | | | | | | | | | |
| Nylon 12 | Rislan | 1.040 | | | | | 50.0% | 22.5% | | | 32.5% |
| | AESNO | | | | | | | | | | |
| | P401 TL | | | | | | | | | | |
| MAGEPDM | Royaltuf | 0.910 | | | | | 10.0% | 20.0% | 10.0% | 20.0% | 13.0% |
| (impact | 498 | | | | | | | | | | |
| modifier) | | | | | | | | | | | |
| MAGPE | Fusabond | 0.870 | | | | 10.0% | 10% | 20% | 10.0% | 10.0% | 13.0% |
| (compatibilizer | MN-493D | | | | | | | | | | |
| Butyl benzene | Uniplex | 1.150 | | | | | | | | | 4.0% |
| sulfonamide | 214 | | | | | | | | | | |
| (Plasticizer) | | | | | | | | | | | |
| Nylon 6, | Dupont | 1.060 | 100% | | | 90.0% | | | 80% | 70.0% | |
| 12 Copolymer | 6/12 | | | | | | | | | | |
| Nylon 6, | Huls | 1.050 | | | 100% | | | | | | |
| 12 Copolymer | Nylon 6, | | | | | | | | | | |
| | 12 | | | | | | | | | | |

| | | | | | | | | | |
|---|---|---|---|---|---|---|---|---|---|
| Totals | 100% | 100% | 100% | 100 | 100% | 100% | 100% | 100% | 100% |
| Properties of Extruded Material | | | | | | | | | |
| Specific gravity (ASTM D-792) | 1.061 | 1.046 | 1.052 | 1.039 | 1.012 | 0.990 | 1.016 | 0.998 | 1.026 |
| Elastic modulus at 230° F. (lb/sq in) | 30150 | 11900 | 30950 | 18100 | 17150 | 7620 | 13810 | 8570 | 17610 |
| Yield strength at 230° F. (lb/sq in) | 3190 | 1071 | 2619 | 2143 | 1381 | 667 | 1470 | 1143 | 1143 |
| Flex modulus (lb/sq in) | 126030 | 55539 | 136887 | 82021 | 64910 | 41522 | 73193 | 53686 | 55249 |
| Low temperature Izod (ft-lbs/in) | 1.3 | 2.8 | 1.47 | 1.95 | NB. | NB | 1.94 | 1.85 | NB |

NB indicates no break

Having thus described the preferred embodiments, the invention is now claimed to be:

1. A hose suitable for use in pressurized fluid systems comprising:
a first layer which comprises:
a polyamide which includes mer units of caprolactam and mer units of at least one of undecanolactam and dodecanolactam, and
a compatibilizer, the compatibilizer being selected from the group consisting of polyolefins modified with an α, β-unsaturated carboxylic acid, polyolefins modified with an alicyclic carboxylic acid, derivatives of polyolefins modified with an α, β-unsaturated carboxylic acid, derivatives of polyolefins modified with an alicyclic carboxylic acid, and combinations thereof.

2. The hose of claim 1, wherein the compatibilizer is selected from the group consisting of polyolefins modified with one of the group consisting of acrylic acid, methacrylic acid, maleic acid, fumaric acid, itaconic acid, endocyclo(2,2,1)-5-heptene-2,3-carboxylic acid, and cis-4cyclohexene-1,2-carboxylic acid, and anhydrides, esters, amides, and imides thereof, and combinations thereof.

3. The hose of claim 2, wherein the compatibilizer includes a maleic anhydride grafted polyalkylene.

4. The hose of claim 3, wherein the compatibilizer includes a maleic anhydride grafted polyethylene.

5. The hose of claim 1, wherein the first layer further includes at least one of:
an impact modifier; and
a plasticizer.

6. The hose of claim 5, wherein the impact modifier includes a maleic anhydride-grafted polyolefin rubber.

7. The hose of claim 6, wherein the impact modifier includes a maleic anhydride-grafted ethylene/propylene/diene elastomer.

8. The hose of claim 5, wherein the plasticizer includes an alkyl aryl sulfonamide.

9. The hose of claim 1, wherein the polyamide includes mer units of dodecanolactam.

10. The hose of claim 9, wherein the polyamide comprises a nylon 6, nylon 12 copolymer and the first layer includes about 50-90% by weight of the nylon 6, nylon 12 copolymer.

11. The hose of claim 10, wherein the layer includes about 65-85% by weight of the nylon 6, nylon 12 copolymer.

12. The hose of claim 1, wherein the layer includes 5-30% by weight compatibilizer.

13. The hose of claim 12, wherein the layer includes 10-20% by weight compatibilizer.

14. The hose of claim 1 further including at least one of a second layer and a third layer bonded directly to the first layer, the second layer, where present, including a polymer of caprolactam, and the third layer, where present, including the one of undecanolactam and dodecanolactam.

15. A hose comprising:
a first layer which includes:
a copolymer comprising at least one of a nylon 6,12 copolymer and a nylon 6,11 copolymer; and
at least one of:
a second layer bonded directly to the first layer, the second layer including nylon 6, and
a third layer bonded directly to the first layer, the third layer including nylon 12 when the copolymer comprises the nylon 6,12 copolymer, the third layer including nylon 11 when the copolymer comprises the nylon 6,11 copolymer.

16. The hose of claim 15, wherein the first layer defines the peripheral surface of the hose for providing protection to the second layer against zinc chloride degradation.

17. The hose of claim 16, wherein the first layer has a thickness of from about 0.1 mm to about 0.46 mm.

18. The hose of claim 15, further including a fourth layer including a reinforcing material.

19. The hose of claim 15, wherein the first layer includes at least one of:
a compatibilizer for rendering the first layer compatible with the at least one of the second and third layers such that the first layer bonds to the at least one of the second and third layers during coextrusion; and
an impact modifier.

20. A method of forming a hose comprising:
coextruding a first layer and a second layer, the first layer bonding to the second layer as the layers are coextruded;
the first layer including a copolymer of nylon 6 and nylon 12 or nylon 6 and nylon 11, and a compatibilizer, which renders the first layer compatible with the second layer for coextrusion;
the second layer including nylon 6.

21. A hose comprising:
an inner peripheral surface and an outer peripheral surface, the outer peripheral surface being radially outwardly spaced from the inner peripheral surface; and
a layer which defines at least one of the inner and outer peripheral surfaces, the layer comprising:
at least about 50% by weight of a nylon 6, nylon 12 copolymer; and
a maleic anhydride modified polymer.
